(19) United States
(12) Patent Application Publication
(10) Pub. No.: US 2011/0174273 A1
(43) Pub. Date: Jul. 21, 2011

(54) Air-Intake Duct for Vehicle and Vehicle

(75) Inventors: Masaya Otsuka, Himeji-shi (JP); Mitsuru Matsushita, Kako-gun (JP); Seiichi Kai, Kobe-shi (JP)

(73) Assignee: KAWASAKI JUKOGYO KABUSHIKI KAISHA, Kobe-shi (JP)

(21) Appl. No.: 12/980,278

(22) Filed: Dec. 28, 2010

(30) Foreign Application Priority Data
Dec. 29, 2009 (JP) 2009-299156

(51) Int. Cl. F02M 61/14

(52) U.S. Cl. 123/470

(57) ABSTRACT

An air-intake duct for a vehicle, which couples a throttle device for controlling an air-intake amount of an engine to an air cleaner for cleaning air guided to the throttle device, includes a tubular wall forming an inlet through which air from the air cleaner flows into the air-intake duct; an outlet through which the air flows out to the throttle device; and an air-intake passage connecting the inlet to the outlet; wherein the tubular wall includes an injector attaching portion to which an injector for injecting fuel to the air-intake passage is attached, and the injector attaching portion has a fuel injection opening section communicating with the air-intake passage.

### CROSS-REFERENCE TO RELATED APPLICATION

This application claims priority to and the benefit of Japanese Patent Application No. 2009-299156 filed on Dec. 29, 2009, the entire disclosure of which is incorporated herein by reference.

### BACKGROUND OF THE INVENTION

1. Field of the Invention

The present invention relates to an air-intake duct for a vehicle for guiding air from an air cleaner to a throttle device, and the vehicle.

2. Description of the Related Art

In a known air-intake system of a motorcycle, air cleaned by an air cleaner is guided to a throttle device via an air-intake duct and then to an engine after its air-intake amount is controlled by a throttle valve. Japanese Laid-Open Patent Application Publication No. 2006-90298 discloses a motorcycle of a so-called twin-injector type in which two injectors are provided to inject fuel to an air-intake passage, for the purpose of attaining a high driving power engine. In this motorcycle, a downstream injector is attached to a throttle device, and an upstream injector is attached to an air cleaner box. Japanese Laid-Open Patent Application Publication No. 2008-207790 discloses a motorcycle including two injectors attached to a throttle device to inject fuel to an air-intake passage. In this motorcycle, an upstream injector is attached to the throttle device at an upstream side of a throttle valve and a downstream injector is attached to the throttle device at a downstream side of the throttle valve.

A suction pressure generated by a piston movement of an engine is transferred to an air cleaner box. Since the suction pressure is blocked when an intake valve of an intake port of the engine is closed, a pulsation is generated in air flowing from the air cleaner box toward the engine. Therefore, in the motorcycle of the first patent reference, a part of fuel injected from the upstream injector to an internal volume space of the air cleaner box is not guided toward the engine but gets stagnant inside the air cleaner box, causing an error in an amount of the fuel to be fed to the engine.

In contrast, in the motorcycle disclosed in the second patent reference, the upstream injector is attached to the throttle device forming the air-intake passage with a small inner diameter. Therefore, even if a pulsation is generated in the air in the air-intake passage of the throttle device, the fuel injected from the upstream injector does not get stagnant, and thus, an error of the amount of fuel fed to the engine is reduced.

However, since the upstream injector is attached to the throttle device, a spot where a temperature of an air-fuel mixture decreases, due to a vaporization heat of the fuel injected by the upstream injector, is located at a downstream side relative to a spot in the example disclosed in patent literature 1. Since a volume of the air-fuel mixture guided to the engine decreases (its density increases) with a decrease in the temperature of the air-fuel mixture, a filling efficiency of the air-fuel mixture to the engine improves and a driving power increases. When the spot where the temperature of the air-fuel-mixture decreases is located the downstream side, it is difficult to improve the filling efficiency of the air-fuel mixture. The length of the throttle device may possibly be increased to position the upstream injector at an upstream side. However, if a metal-made throttle device is increased in size, its weight increases undesirably. In addition, if the length of the throttle device increases, the position of the air cleaner box must be changed correspondingly. It is difficult to change the position of the air cleaner box in a limited component arrangement space of the motorcycle.

### SUMMARY OF THE INVENTION

An object of the present invention is to suitably achieve both reduction of an error of an amount of fuel fed to an engine and improvement of a filling efficiency of an air-fuel mixture.

An air-intake duct for a vehicle of the present invention, which couples a throttle device for controlling an air-intake amount of an engine to an air cleaner for cleaning air guided to the throttle device, comprises a tubular wall forming an inlet through which air from the air cleaner flows into the air-intake duct; an outlet through which the air flows out to the throttle device; and an air-intake passage connecting the inlet to the outlet; wherein the tubular wall includes an injector attaching portion to which an injector for injecting fuel to the air-intake passage is attached, and the injector attaching portion has a fuel injection opening section communicating with the air-intake passage.

In accordance with this configuration, since the injector is attached to the air-intake duct, the injected fuel is less likely to get stagnant and an error of an amount of the fuel fed to the engine is reduced, as compared to a case where the injector is attached to the air cleaner. Since the injector is attached to the air-intake duct, the spot where the temperature of the air-fuel mixture decreases due to vaporization heat of the fuel injected by the injector is located upstream of the throttle device. This results in an improved filling efficiency of the air-fuel mixture to the engine. As a result, reduction of the error of the amount of fuel fed to the engine and improvement of the filling efficiency of the air-fuel mixture are both achieved suitably.

The tubular wall may include a pipe-shaped portion connected to the throttle device; and a chamber portion which is provided upstream of the pipe-shaped portion in an air flow direction and has a larger inner diameter larger than the pipe-shaped portion. The fuel injection opening section may be provided in the pipe-shaped portion.

In accordance with this configuration, in the air-intake duct having the pipe-shaped portion and the chamber portion, since the fuel injection opening section is formed in the pipe-shaped portion which is downstream of the chamber portion and has a smaller inner diameter than the chamber portion, the fuel injected from the injector to the air-intake passage through the fuel injection opening section is less likely to get stagnant, and an error of the fuel fed to the engine can be further reduced.

The tubular wall may be formed of an elastic material; and the injector attaching portion may protrude radially outward from the pipe-shaped portion and may be continuous with an outer surface of the chamber portion.

In accordance with this configuration, since the injector attaching portion serves as a reinforcement rib, it is possible to prevent the chamber portion from depressing inward even when a negative pressure is suddenly generated in the chamber, for example, when the engine is accelerated. As a result, a high air-intake efficiency is maintained and an acceleration response is improved.

The chamber portion may include a first portion which is close to the injector attaching portion in a circumferential position and a second portion which is at an opposite side of the first portion in a circumferential position. The second portion may be longer than the first portion in the air flow direction.

In accordance with this configuration, since the second portion of the chamber portion is longer than the first portion of the chamber portion in the air flow direction, a sufficient volume of the chamber portion can be ensured, even though the first portion of the chamber portion has a size for allowing for a space in which the injector is disposed in the vicinity of the first portion Therefore, a high air-intake efficiency can be maintained while maintaining flexibility with which the injector is disposed.

The second portion may cover the pipe-shaped portion such that there is a gap between the second portion and an outer surface of an upstream portion of the pipe-shaped portion, and an end portion of the second portion which is located at the pipe-shaped portion side may be connected to an intermediate portion of the pipe-shaped portion in the air flow direction.

In accordance with this configuration, it is possible to avoid the length of the pipe-shaped portion from being reduced although the length of the second portion is made longer than that of the first portion in the air flow direction. Therefore, because of the small-diameter pipe-shaped portion, generation of a disturbed flow can be sufficiently suppressed and a high air-intake efficiency can be maintained.

An end portion of a portion of the pipe-shaped portion which is covered with the second portion may have a diameter increased toward a tip end, the end portion protruding into an inner space of the chamber portion.

In accordance with this configuration, air present in the chamber portion is guided smoothly to the pipe-shaped portion, and thus an air-intake resistance can be reduced.

The air-intake duct may further comprise an injector fastening bracket provided at the chamber portion, the tubular wall may be formed of an elastic material, and the injector fastening bracket may be formed of a stiff material.

In accordance with this configuration, since the injector fastening bracket serves to reinforce the chamber portion, it is possible to prevent the chamber portion from depressing inward even when a negative pressure is suddenly generated in the chamber portion, for example, when the engine is accelerated. Therefore, a high air-intake efficiency can be maintained and an acceleration response can be improved.

The injector fastening bracket may include a first injector support portion disposed in the fuel injection opening section such that the first injector support portion surrounds a front end portion of the injector and a second injector support portion provided at the chamber portion and attached with a fastening member for supporting the injector.

In accordance with this configuration, even if the chamber portion is depressed to a certain degree by a negative pressure suddenly generated in the chamber portion, for example, when the engine is accelerated, it is possible to prevent the injector from disengaging from the injector attaching portion because a positional relationship between the first injector support portion and the second injector support portion is determined by the injector fastening bracket.

The tubular wall may have a recess in which the injector attached to the injector attaching portion is disposed, when viewed from above.

In accordance with this configuration, the wall surface of the recess can protect the injector attached to the injector attaching portion from mud and the like splashing.

The tubular wall may be provided with a cover portion for covering the injector attached to the injector attaching portion.

In accordance with this configuration, the cover portion can protect the injector attached to the injector attaching portion from mud and the like splashing.

The cover portion may be positioned outward relative to the injector, when viewed from a vehicle body of the vehicle, and may be integral with the tubular wall such that the cover portion covers the injector from a side.

In accordance with this configuration, the cover portion covers the injector from outside when viewed from the vehicle body, more effectively. Since the cover portion is integral with the tubular wall, the number of components does not increase, and the air-intake duct can be handled easily.

A vehicle of the present invention comprises an engine; a throttle device for controlling an air-intake amount of the engine; an air-intake duct for guiding air to the throttle device; an air cleaner for cleaning the air guided to the air-intake duct; a downstream injector attached to the throttle device to inject fuel to an air-intake passage inside the throttle device; and an upstream injector attached to the air-intake duct to inject fuel to an air-intake passage of the air-intake duct.

In accordance with this configuration, in the vehicle including twin injectors, since the upstream injector is attached to the air-intake duct, the injected fuel is less likely to get stagnant and an error of an amount of the fuel fed to the engine is reduced, as compared to a case where the upstream injector is attached to the air cleaner. Since the upstream air-injector is attached to the air-intake duct, the spot where the temperature of the air-fuel mixture decreases due to vaporization heat of the fuel injected by the upstream injector is located upstream of the throttle device. This results in an improved filling efficiency of the air-fuel mixture to the engine. As a result, reduction of the error of the amount of fuel fed to the engine and improvement of the filling efficiency of the air-fuel mixture are both achieved suitably.

The above and further objects and features of the invention will more fully be apparent from the following detailed description with accompanying drawings.

### BRIEF DESCRIPTION OF THE DRAWINGS

FIG. 1 is a left side view showing a motorcycle according to Embodiment 1 of the present invention.

FIG. 2 is a left side view of major components, showing an air-intake duct of the motorcycle of FIG. 1 and a region surrounding the air-intake duct.

FIG. 3 is a perspective view showing the air-intake duct of FIG. 2, when viewed from leftward and obliquely forward.

FIG. 4 is a longitudinal sectional view of the air-intake duct of FIG. 3.

FIG. 5 is a left side view of major components showing a positional relationship between the air-intake duct and a main frame in the motorcycle of FIG. 1.

FIG. 6 is a plan view showing the air-intake duct of the motorcycle of FIG. 1 and the region surrounding the air-intake duct.

FIG. 7 is a left side view of an air-intake duct according to Embodiment 2 of the present invention.

FIG. 8 is a plan view of the air-intake duct of FIG. 7.

FIG. 9 is a right side view of major components of the air-intake duct of FIG. 7.

### DETAILED DESCRIPTION OF THE PREFERRED EMBODIMENTS

Hereinafter, embodiments of the present invention will be described with reference to the drawings. The stated directions are referenced from the perspective of a driver straddling the motorcycle.

### Embodiment 1

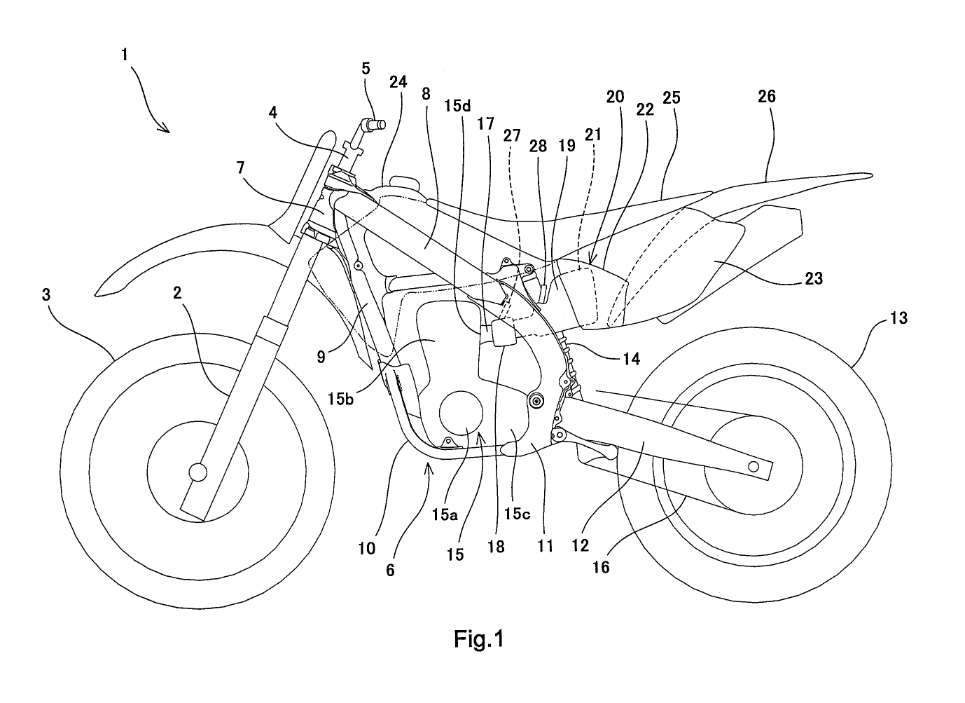

FIG. 1 is a left side view of a motorcycle 1 according to Embodiment 1 of the present invention. As shown in FIG. 1, the motorcycle 1 is of a motocross type motorcycle for driving off-road. The motorcycle 1 includes a front fork 2 extending substantially vertically with a predetermined caster angle. A front wheel 3, which is a drive wheel, is rotatably mounted to a lower portion of the front fork 2. A lower portion of a steering shaft 4 is coupled to an upper portion of the front fork 2. A bar-type handle 5 is attached to an upper portion of the steering shaft 4. The steering shaft 4 is rotatably inserted into a head pipe 7 forming a frame 6. When a driver rotates the handle 5, the front wheel 3 is steered.

The frame 6 includes a head pipe 7 and a pair of right and left main frames 8 extending rearward from an upper portion of the head pipe 7 such that the main frames 8 are tilted slightly downward. An upper portion of a down frame 9 extending downward in a slightly rearward direction is coupled to a lower portion of the head pipe 7. A lower frame 10 extends rearward from a lower portion of the down frame 9 such that the lower frame 10 is curved in a substantially L-shape, when viewed from a side. A rear portion of the main frame 8 is coupled to a rear portion of the lower frame 10 by each of a pair of right and left swing arm brackets 11. A swing arm 12 extending substantially in a forward and rearward direction is pivotally mounted at a front portion thereof to the swing arm bracket 11. A rear wheel 13 which is a drive wheel is rotatably mounted to a rear portion of the swing arm 12. A rear suspension 14 extending substantially vertically is provided between the swing arm 12 and an upper portion of the swing arm bracket 11.

An engine 15 is mounted in a space defined by the frame 6 and is fastened to respective portions of the frame 6. The engine 15 includes a crankcase 15a, a cylinder 15b extending upward from an upper portion of the crankcase 15a, and a transmission 15c extending rearward from a rear portion of the crankcase 15a. An output shaft (not shown) of the transmission 15c transmits a driving power to the rear wheel 13 via a chain 16. An intake port 15d which opens rearward is formed at a rear portion of the cylinder 15b of the engine 15. A throttle device 18 is coupled to the intake port 15d via a pipe-shaped holder 17 extending rearward. An air-intake duct 19 is coupled to a rear portion of the throttle device 18 and an air cleaner 20 is coupled to a rear portion of the air-intake duct 19.

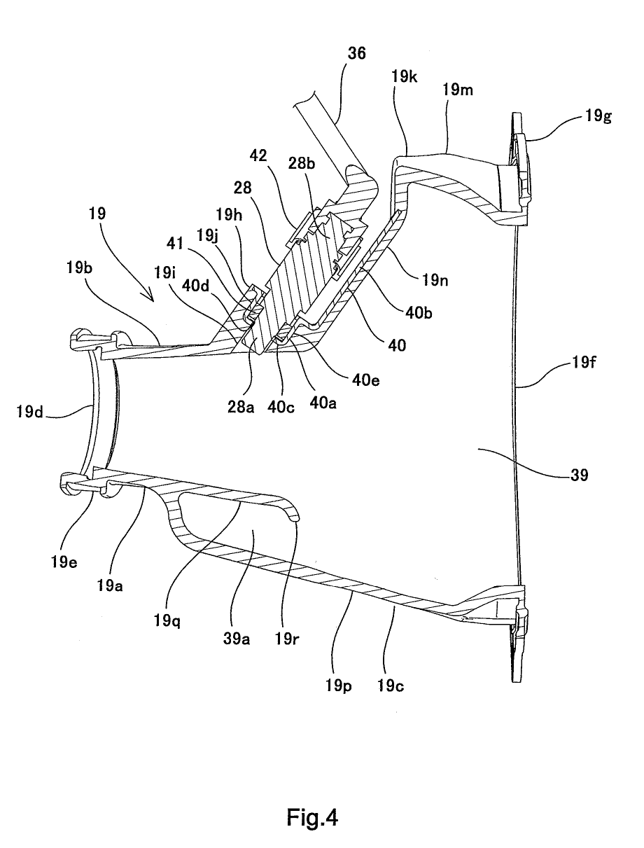

The air cleaner 20 cleans air taken in from outside using an air cleaner element 21 and guides the cleaned air to the air-intake duct 19. To be specific, an opening of the air cleaner element 21 which has a bottomed cylinder shape and is formed by a sponge material faces an inlet 19f (see FIG. 4) of the air-intake duct 19 and the air cleaner element 21 closes the inlet 19f (see FIG. 4) of the air-intake duct 19. An air cleaner holding frame 22 is attached to the air cleaner element 21 and forms side walls of the air cleaner element 21. A side cover 23 is disposed behind and continuously with the air cleaner holding frame 22.

A fuel tank 24 is disposed above the main frames 8. A seat 25 straddled by the driver is disposed behind the fuel tank 24. A rear fender 26 is positioned behind and in close proximity to the air cleaner element 21 below the seat 25. Air in a space defined by the air cleaner holding frame 22, the side cover 23, the seat 25 and the rear fender 26 flows through the air cleaner element 21 and then is supplied to the intake port 15d of the engine 15 through the air-intake duct 19, the throttle device 18, and the pipe-shaped holder 17 in this order. As a fuel feeding method of the motorcycle 1, a twin injector method in which two injectors 27 and 28 are provided, is used. Fuel fed from the fuel tank 24 is injected to two spots in the air-intake passage individually. This makes it possible to reduce an injection time per fuel injection and to set fuel injection timings with large intervals, as compared to a case where fuel injection is performed using a single injector. Therefore, it is possible to set an optimal injection timing under a high engine speed condition.

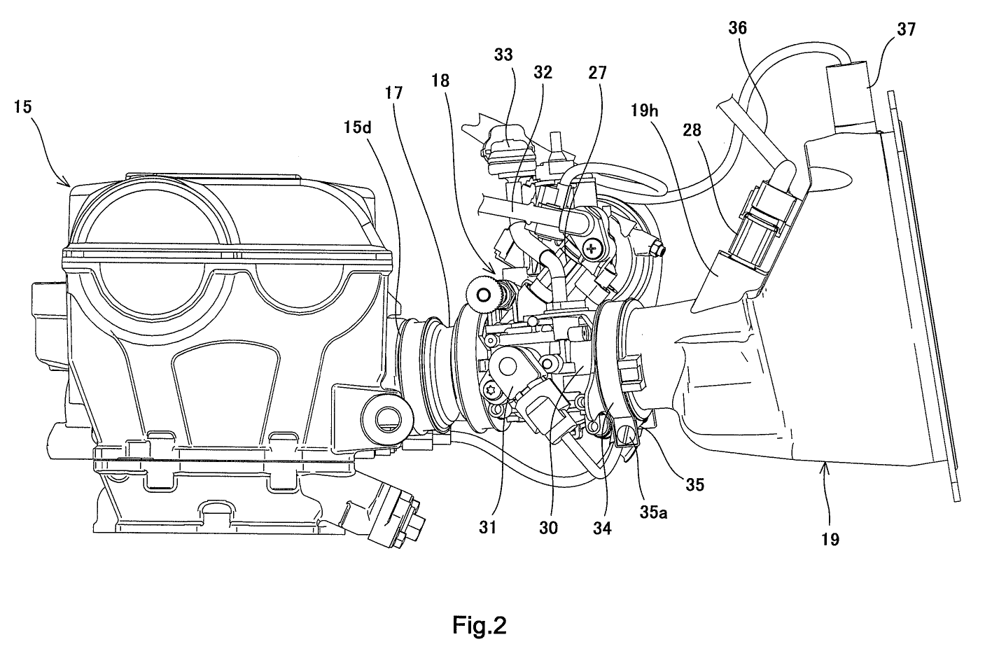

FIG. 2 is a left side view of major components, showing the air-intake duct 19 of the motorcycle 1 of FIG. 1 and a region surrounding the air-intake duct 19. As shown in FIG. 2, an air-intake passage connecting the intake port 15d of the engine 15 to the air cleaner 20 (see FIG. 1) is formed by the pipe-shaped holder 17, the throttle device 18 and the air-intake duct 19. The pipe-shaped holder 17, the throttle device 18, the air-intake duct 19 and the air cleaner 20 are arranged substantially horizontally in this order in a rearward direction. The pipe-shaped holder 17 is a tubular member for coupling the intake port 15d to the throttle device 18. The throttle device 18 has a body 30 forming its air-intake passage, and a butterfly throttle valve (not shown) is provided inside the body 30 to control an air-intake amount.

A downstream injector 27 is attached to a body 30 of the throttle device 18 to inject the fuel to its air-intake passage. The downstream injector 27 is attached to an upper portion of the body 30 to extend in a tilted state such that its front end injection port (not shown) faces obliquely forward, and injects fuel to a region of the air-intake passage which is near and downstream of a throttle valve (not shown). A feed tube 32 is coupled to a rear end of the downstream injector 27, and the fuel outflowing from the fuel tank 24 flows through the feed tube 32. An air-intake pressure sensor 33 is coupled to the body 30 of the throttle device 18 to detect an air-intake pressure in the air-intake passage.

A downstream end portion of the air-intake duct 19 is externally fitted to a rear end of the throttle device 18. In this state, a C-shaped metal band 34 is fitted to the end portion of the air-intake duct 19 and is fastened thereto by a bolt 35. An upstream injector 28 is attached to the air-intake duct 19 to inject the fuel to the air-intake passage inside thereof. A fuel guide pipe 36 is coupled to a rear end of the upstream injector 28. Fuel guided from the fuel tank 24 through the feed tube (not shown) flows into the fuel guide pipe 36. A temperature sensor 37 is attached on the air-intake duct 19 to detect a temperature of the air flowing in the air-intake passage.

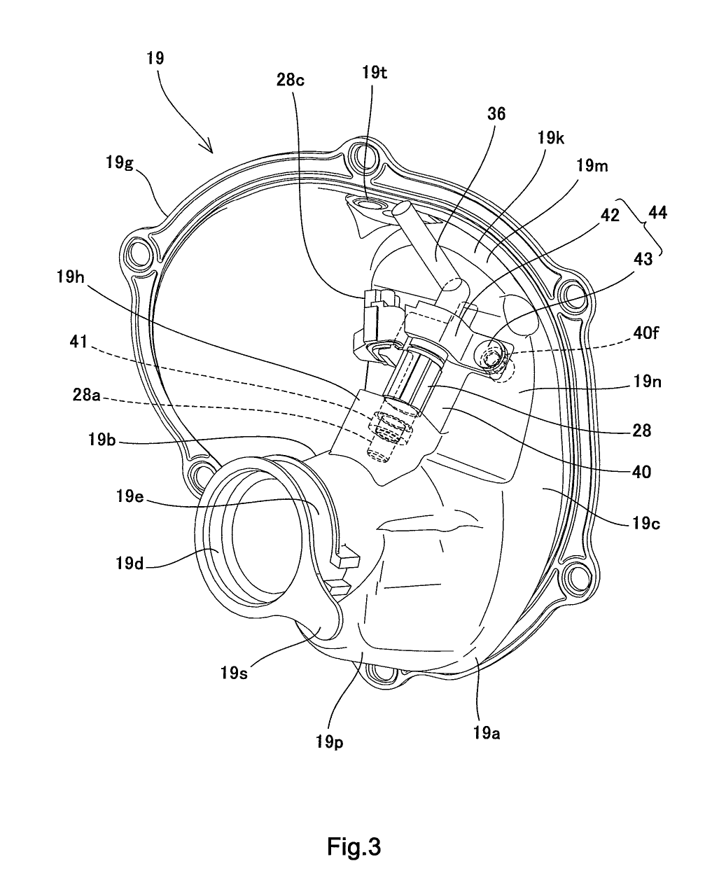

FIG. 3 is a perspective view showing the air-intake duct 19 of FIG. 2, as viewed from leftward and obliquely forward. FIG. 4 is a longitudinal sectional view of the air-intake duct 19 of FIG. 3. As shown in FIGS. 3 and 4, the air-intake duct 19 includes a tubular wall 19a made of elastomer resin such as rubber which is an elastic material and an injector fastening bracket 40 which is integral with the tubular wall 19a and is made of a stiff material such as metal or resin. The tubular wall 19a includes a pipe-shaped portion 19b coupled to the throttle device 18 (see FIG. 1) and a chamber portion 19c which is provided continuously with an upstream side (rear side) of the pipe-shaped portion 19b in an air flow direction and has a larger inner diameter than the pipe-shaped portion 19b. An outlet 19d is formed at a front end portion of the pipe-shaped portion 19b and air flows out to the throttle device 18 (see FIG. 1) through the outlet 19d. An inlet 19f is formed at a rear end portion of the chamber portion 19c and the air from the air cleaner 20 (see FIG. 1) flows into the inlet 19f. An inner space connecting the inlet 19f to the outlet 19d is an air-intake passage 39.

A band mounting annular recess 19e is formed on an outer peripheral surface of a front end portion of the pipe-shaped portion 19b. A holding tongue portion 19s protrudes radially outward from a portion of a front end of the pipe-shaped portion 19b. An injector attaching portion 19h for attaching the upstream injector 28 protrudes radially outward and upward from an upper portion of the pipe-shaped portion 19b. A fuel injection opening section 19i of a substantially cylindrical shape is formed in the injector attaching portion 19h to provide a communication between outside and the air-intake passage 39. The fuel injection opening section 19i communicates with a region of the air-intake passage 39 which is defined by the pipe-shaped portion 19b. The fuel injection opening section 19i is tilted such that its lower side (air-intake passage side) faces obliquely forward. The fuel injection opening section 19i has an upper large-diameter portion 19j in an upper region (outer region) such that the upper large-diameter portion 19j has a larger diameter than a lower region (air-intake passage side region).

As described above, the upstream injector 28 is attached to the injector attaching portion 19h of the air-intake duct 19. Therefore, the injected fuel is suppressed from getting stagnant as compared to a case where the upstream injector 28 is attached to the air cleaner 20. In addition, since the fuel injection opening section 19i is formed at the pipe-shaped portion 19b which is downstream of the chamber portion 19c and has a smaller inner diameter than the chamber portion 19c, the fuel injected from the upstream injector 28 to the air-intake passage 39 through the fuel injection opening section 19i is sufficiently suppressed from getting stagnant therein. As a result, an error of the amount of the fuel fed to the engine 15 is lessened. In addition, since the upstream injector 28 is attached to the air-intake duct 19, the spot where the temperature of the air-fuel mixture decreases due to vaporization heat of the fuel injected by the upstream injector 28 is located upstream relative to the throttle device 18, thereby resulting in an improved filling efficiency of the air-fuel mixture to the engine 15. As a result, reduction of the error of the amount of fuel fed to the engine 15 and improvement of the filling efficiency of the air-fuel mixture are both achieved suitably.

A portion of the injector attaching portion 19h is continuous with an upper outer surface of the chamber portion 19c. This allows the injector attaching portion 19h to serve as a reinforcement rib. Therefore, it is possible to prevent the chamber portion 19c from depressing inward even when a negative pressure is suddenly generated in the chamber portion 19c, for example, when the engine is accelerated. As a result, a high air-intake efficiency is maintained and an acceleration response is improved.

The chamber portion 19c has an unsymmetric shape in an upward and downward direction and in a rightward and leftward direction and has a diameter substantially decreasing in a direction from the inlet 19f toward the pipe-shaped portion 19b. To be specific, the pipe-shaped portion 19b is positioned leftward relative to a center of the chamber portion 19c. A flange portion 19g is provided at a rear end of the chamber portion 19c and coupled to the air cleaner 20 (see FIG. 1). The chamber portion 19c has an upper portion 19k (first portion) which is close to the injector attaching portion 19h and a lower portion 19p (second portion) which is at an opposite side of the upper portion 19k in a circumferential direction. The lower portion 19p is longer than the upper portion 19k in the air flow direction. The lower portion 19p allows the chamber portion 19c to sufficiently ensure its volume, although a space for the upper portion 19k of the chamber portion 19c is constrained by the upstream injector 28 disposed in the vicinity of the upper portion 19k. As a result, a high air-intake efficiency is maintained while disposing the upstream injector 28 flexibly.

The upper portion 19k of the chamber portion 19c has a large-diameter portion 19m which is located at the flange portion 19g side and is provided with a temperature sensor attaching portion 19t and a small-diameter portion 19n having a diameter decreasing in a direction from the large-diameter portion 19m toward the pipe-shaped portion 19b. The lower portion 19p of the chamber portion 19c covers an outer surface side of a lower rear portion 19q of the pipe-shaped portion 19b with a gap 39a provided therebetween. A front end portion of the lower portion 19p is coupled to an intermediate portion of the pipe-shaped portion 19b in the flow direction. This makes it possible to prevent the length of the pipe-shaped portion 19b from being reduced while making the lower portion 19p of the chamber portion 19c longer than the upper portion 19k in the air flow direction. With the pipe-shaped portion 19b with a smaller diameter, generation of a disordered flow can be sufficiently suppressed, and as a result, a high air-intake efficiency is maintained.

The lower rear portion 19q of the pipe-shaped portion 19b which is covered with the lower portion 19p has an end portion 19r protruding into an inner space of the chamber portion 19c and having a funnel shape in which its diameter increases toward a tip end. With this structure, the air present in the chamber portion 19c is guided smoothly to the pipe-shaped portion 19b, and thus, an air-intake resistance in the interior of the air-intake duct 19 is reduced.

The injector fastening bracket 40 is formed by, for example, press-forming of a metal plate. The injector fastening bracket 40 is integral with the tubular wall 19a by insert molding when forming the tubular wall 19a. The injector fastening bracket 40 includes a first injector support portion 40 disposed at the upper large-diameter portion 19j of the fuel injection opening section 19i of the injector attaching portion 19h and surrounding the front end portion 28a of the upstream injector 28, and a second injector support portion 40b disposed at an outer surface of the small-diameter portion 19n of the upper portion 19k of the chamber portion 19c.

The first injector support portion 40a includes a tubular side wall portion 40e continuous with the second injector support portion 40b, and an annular bottom portion 40c which is provided continuously with a lower end of the tubular side wall 40e and has a center hole 40d. The front end portion 28a of the upstream injector 28 is disposed in the fuel injection opening section 19i such that it is inserted into the center hole 40d. An annular seal member 41 is provided between an outer peripheral surface of the upstream injector 28 and the tubular side wall 40e of the first injector support portion 40a in an air-tight manner.

A fuel guide pipe 36 is coupled to a rear end portion 28b of the upstream injector 28. A connector 28c for connecting electric wires is provided in a location rightward relative to the fuel guide pipe 36 (close to the center of the vehicle body). A stay 42 is provided integrally with the fuel guide pipe 36. The stay 42 is fastened to the second injector support portion 40b by a fastener member 43 (e.g., threaded member, screw, etc). In other words, the stay 42 and the fastening member 43 are a fastening member 44 for supporting the upstream injector 28 and fastening it to the second injector support portion 40b. In this state, the upstream injector 28 is disposed to be tilted along the outer surface of the chamber portion 19c such that the front end portion 28a faces obliquely forward in the fuel injection opening section 19i.

In such a configuration, since the injector fastening bracket 40 serves to reinforce the chamber portion 19c, it is possible to prevent the chamber portion 19c from depressing inward even when a negative pressure is suddenly generated in the chamber portion 19c, for example, when the engine is accelerated. As a result, a high air-intake efficiency is maintained and an acceleration response is improved. Even if the chamber portion 19c is depressed to a certain degree by a high negative pressure generated in the chamber portion 19c, for example, when the engine is accelerated, it is possible to prevent the upstream injector 28 from disengaging from the injector attaching portion 19h because a positional relationship between the first injector support portion 40a and the second injector support portion 40b is determined by the injector fastening bracket 40.

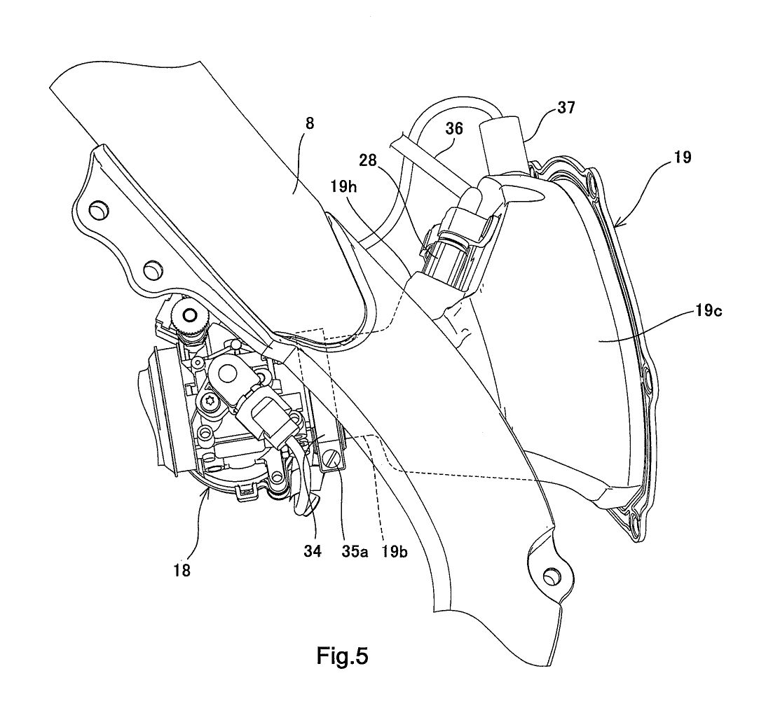

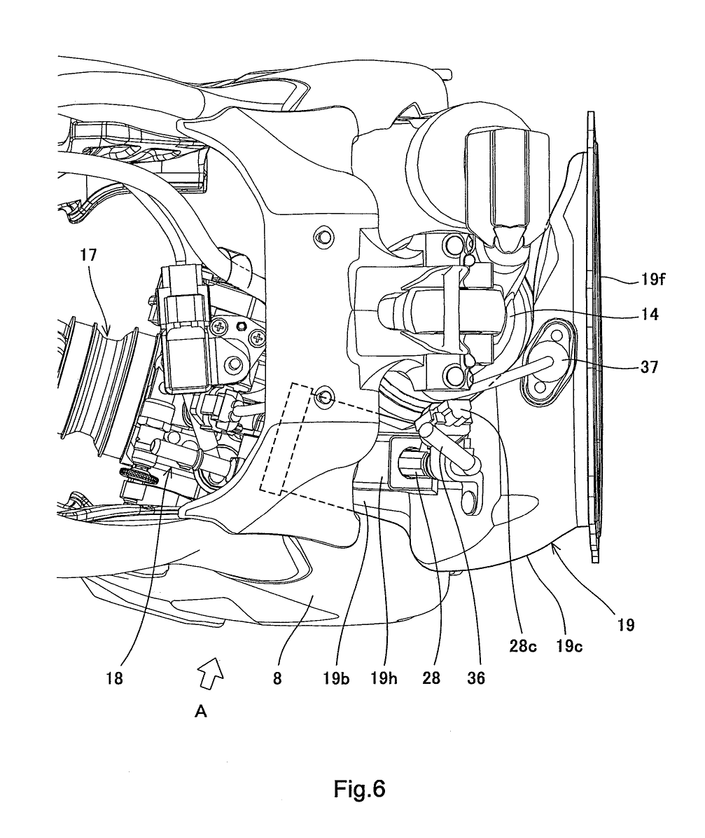

FIG. 5 is a left side view of major components showing a positional relationship between the air-intake duct 19 and the main frame 8 in the motorcycle 1 of FIG. 1. FIG. 5 is a side view when viewed in a direction (in the direction along A in FIG. 6) perpendicular to a passage axis of the pipe-shaped portion 19b of the air-intake duct 19. As shown in FIG. 5, the main frame 8 is disposed to extend from left and obliquely upper to right and obliquely lower, at a left side of the air-intake duct 19. The main frame 8 substantially passes through a space leftward relative to and beside the pipe-shape portion 19b of the air-intake duct 19. However, a head portion 35a of a bolt 35 for fastening the metal band 34 used for fastening the air-intake duct 19 to the throttle device 18 is not covered with the main frame 8. In other words, the main frame 8 is not disposed above an axis of the bolt 35, which allows a tool to easily access the head portion 35a of the bolt 35.

FIG. 6 is a plan view of the air-intake duct 19 of the motorcycle 1 of FIG. 1 and the region surrounding the air-intake duct 19. As shown in FIG. 6, the air-intake duct 19 is disposed to pass through a space leftward relative to the rear suspension 14 positioned at a center in a lateral direction of the vehicle body. The inlet 19f of the air-intake duct 19 is positioned behind the rear suspension 14 and extends from right and obliquely rear to left and obliquely rear of the rear suspension 14. A right side surface of the chamber portion 19c of the air-intake duct 19 is curved along the rear suspension 14.

The passage axis of the pipe-shaped portion 19b of the air-intake duct 19 is slightly tilted rightward and obliquely forward such that a front end of the pipe-shaped portion 19b is closer to a center in the lateral direction of the vehicle body. Such a tilted arrangement can avoid the head portion 35a of the bolt 35 (see FIG. 5) for fastening the metal-made band 34 (see FIG. 5) from being hidden by the main frame 8, when viewed from a side.

The fuel guide pipe 36 coupled to the upstream injector 28 is disposed outward (leftward) relative to the connector 28c of the upstream injector 28 in the lateral direction of the vehicle body. In this structure, the fuel guide pipe 36 is located outward relative to an electric wire (not shown) connected to the connector 28c, and therefore, maintenance of the fuel guide pipe 36 is easily performed. In addition, since the electric wire (not shown) connected to the connector 28c is disposed at a center of the vehicle body, it is possible to prevent the electric wire (not shown) from contacting an obstacle and being disconnected, during driving off-road.

### Embodiment 2

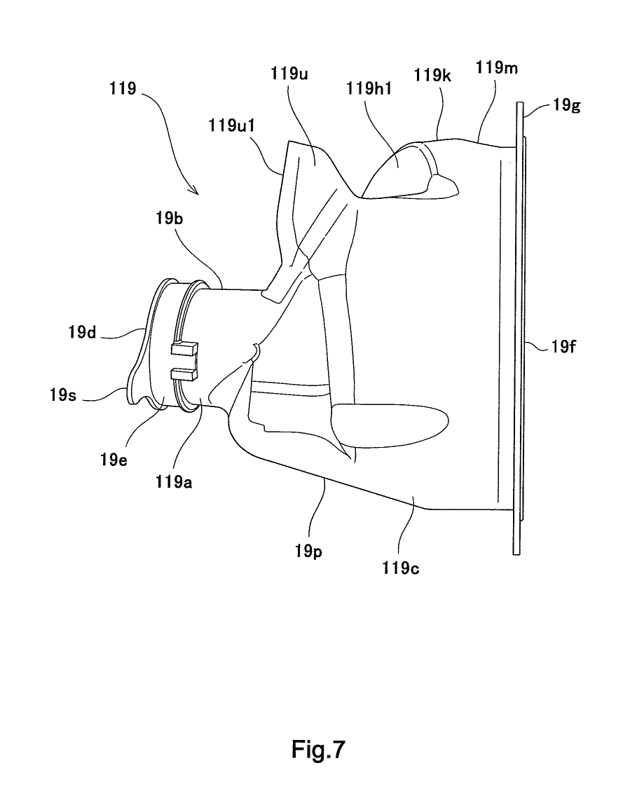

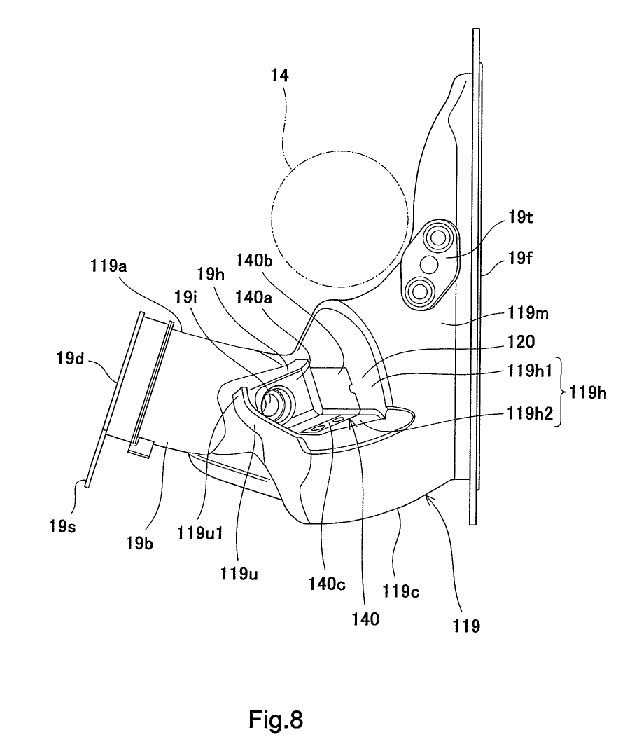

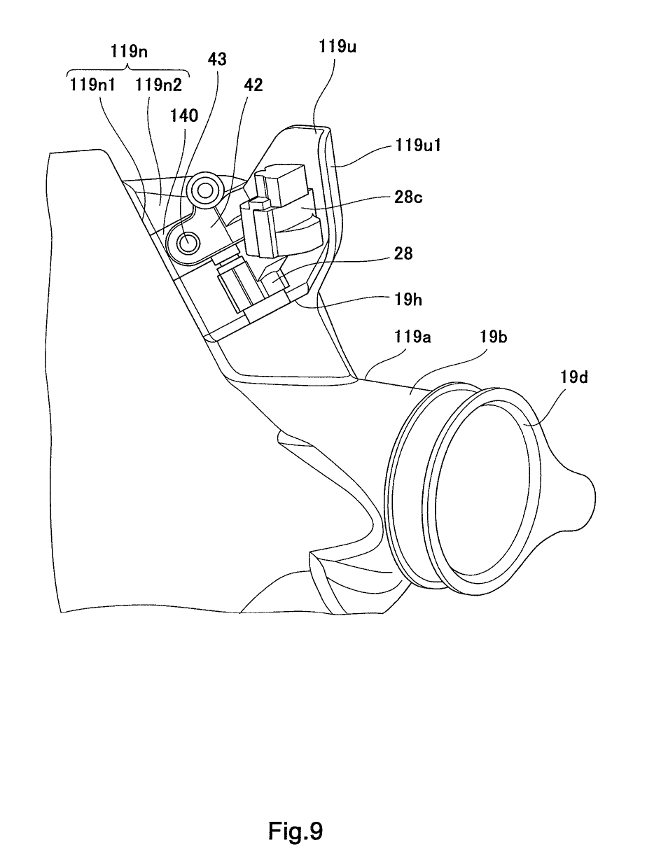

FIG. 7 is a left side view of an air-intake duct 119 according to Embodiment 2 of the present invention. FIG. 8 is a plan view of the air-intake duct 119 of FIG. 7. FIG. 9 is a right side view of major constituents of the air-intake duct 119 of FIG. 7. Hereinafter, the same constituents as those in Embodiment 1 are designated by the same reference numerals and will not be described repetitively. As shown in FIGS. 7-9, a tubular wall 119a of the air-intake duct 119 of this embodiment has a structure for protecting the injector 28 from mud and the like splashing during driving off-road. An upper portion 119k of the chamber portion 119c of the air-intake duct 119 has a large-diameter portion 119m which is located at the flange portion 19g side and is provided with the temperature sensor attaching portion 19t and a small-diameter portion 119n having a diameter decreased from the large-diameter portion 119m toward the pipe-shaped portion 19b.

The small-diameter portion 119n has a recess 120 (see FIG. 8) which is depressed in a rearward direction when viewed from above. In the recess 120, the injector 28 (see FIG. 9) attached on the injector attaching portion 19h is disposed in the recess 120. In other words, a wall surface of the recess 120 serves as a cover for protecting the injector 28 from mud and the like splashing during driving off-road. To be specific, the small-diameter portion 119n includes a right small-diameter portion 119n1 positioned at a right side of the injector 28 to vertically extend at the right side of the injector attaching portion 19h and a left small-diameter portion 119n2 positioned at a left side of the injector 28 to vertically extend at the left side of the injector attaching portion 19h. The right small-diameter portion 119n1 and the left small-diameter portion 119n2 are tilted to form a substantially V-shape when viewed from above.

An injector fastening bracket 140 is formed by insert molding to be integral with the tubular wall 119a and the chamber portion 119c when forming the tubular wall 119a and the chamber portion 119c. The injector fastening bracket 140 includes a first injector support portion 140a which is disposed in the fuel injection opening section 19i of the injector attaching portion 19h so as to surround a front end portion of the injector 28, a second injector support portion 140b disposed on an outer surface of the right small-diameter portion 119n1 continuously with the first injector support portion 140a, and a third injector support portion 140c disposed on an outer surface of the left small-diameter portion 119n2 continuously with the second injector support portion 140b.

A plate-shaped cover portion 119u is provided to protrude from a front end portion of the left small-diameter portion 119n2 and a portion of the injector attaching portion 19h which is leftward relative to the fuel injection opening section 19i. In other words, the cover portion 119u is formed integrally with the tubular wall 119a. The cover portion 119u covers a left side to a front side of the injector 28 attached to the injector attaching portion 19h. In other words, the cover portion 119u is disposed to cover the injector 28 from an opposite side of the rear suspension 14 with respect to the injector attaching portion 19h. Since a left side which is an opposite side of the rear suspension 14 is outside of the vehicle body, the cover portion 119u serves to sufficiently protect the injector 28 from mud and the like splashing outside the vehicle body, during driving off-road. A front end portion 119u1 of the cover portion 119u is curved to cover the injector 28 from forward when viewed from above. The front end portion 119u1 of the cover portion 119u is positioned so as to cover the connector 28c of the injector 28. The cover portion 119u protrudes upward such that the cover portion 119u is higher than the left small-diameter portion 119n2 (see FIGS. 7 and 9). The other constituents are identical to those of Embodiment 1 described above and will not be described repetitively.

Although in this embodiment, the present invention is applied to the motorcycle, the present invention is applicable to vehicles which are driven by an engine driving power. The vehicles include, for example, a four-wheeled automobile, and straddle-type vehicles including seats which are straddled by a driver. The straddle-type vehicles include the motorcycle, an ATV (all terrain vehicle), and small personal watercraft (PWC).

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An air-intake duct for a vehicle, which couples a throttle device for controlling an air-intake amount of an engine to an air cleaner for cleaning air guided to the throttle device, the air-intake duct comprising:
a tubular wall forming an inlet through which air from the air cleaner flows into the air-intake duct;
an outlet through which the air flows out to the throttle device; and
an air-intake passage connecting the inlet to the outlet;
wherein the tubular wall includes an injector attaching portion to which an injector for injecting fuel to the air-intake passage is attached, and the injector attaching portion has a fuel injection opening section communicating with the air-intake passage.

2. The air-intake duct according to claim 1,
wherein the tubular wall includes:
a pipe-shaped portion connected to the throttle device; and
a chamber portion which is provided upstream of the pipe-shaped portion in an air flow direction and has a larger inner diameter than the pipe-shaped portion; and
wherein the fuel injection opening section is provided in the pipe-shaped portion.

3. The air-intake duct according to claim 2, wherein
the tubular wall is formed of an elastic material; and
the injector attaching portion protrudes radially outward from the pipe-shaped portion and is continuous with an outer surface of the chamber portion.

4. The air-intake duct according to claim 2, wherein
the chamber portion includes a first portion which is close to the injector attaching portion in a circumferential position and a second portion which is at an opposite side of the first portion in a circumferential position; and
the second portion is longer than the first portion in the air flow direction.

5. The air-intake duct according to claim 4,
wherein the second portion covers the pipe-shaped portion such that there is a gap between the second portion and an outer surface of an upstream portion of the pipe-shaped portion, and an end portion of the second portion which is located at the pipe-shaped portion side is connected to an intermediate portion of the pipe-shaped portion in the air flow direction.

6. The air-intake duct according to claim 5,
wherein an end portion of a portion of the pipe-shaped portion which is covered with the second portion has a diameter increased toward a tip end, the end portion protruding into an inner space of the chamber portion.

7. The air-intake duct according to claim 1, further comprising:
an injector fastening bracket provided at a chamber portion,
wherein the tubular wall is formed of an elastic material, and the injector fastening bracket is formed of a stiff material.

8. The air-intake duct according to claim 7,
wherein the injector fastening bracket includes a first injector support portion, disposed in the fuel injection opening section such that the first injector support portion surrounds a front end portion of the injector, and a second injector support portion provided at the chamber portion and attached with a fastening member for supporting the injector.

9. The air-intake duct according to claim 1,
wherein the tubular wall has a recess in which the injector attached to the injector attaching portion is disposed when viewed from above.

10. The air-intake duct according to claim 1,
wherein the tubular wall is provided with a cover portion for covering an injector attached to the injector attaching portion.

11. The air-intake duct according to claim 10,
wherein the cover portion is positioned outward relative to the injector, when viewed from a vehicle body of the vehicle, and is integral with the tubular wall such that the cover portion covers the injector from a side.

12. A vehicle comprising:
an engine;
a throttle device for controlling an air-intake amount of the engine;
an air-intake duct for guiding air to the throttle device;
an air cleaner for cleaning the air guided to the air-intake duct;
a downstream injector attached to the throttle device to inject fuel to an air-intake passage inside the throttle device; and
an upstream injector attached to the air-intake duct to inject fuel to an air-intake passage of the air-intake duct.
